(19) United States
(12) Patent Application Publication
(10) Pub. No.: US 2014/0232847 A1
(43) Pub. Date: Aug. 21, 2014

(54) MIRROR UNIT AND IMAGE ACQUISITION UNIT

(71) Applicant: CANON KABUSHIKI KAISHA, Tokyo (JP)

(72) Inventors: Naoto FUSE, Kawasaki-shi (JP); Yuji SUDOH, Kawasaki-shi (JP)

(73) Assignee: CANON KABUSHIKI KAISHA, Tokyo (JP)

(21) Appl. No.: 14/183,663

(22) Filed: Feb. 19, 2014

(30) Foreign Application Priority Data
Feb. 20, 2013 (JP) 2013-031474

(51) Int. Cl. G02B 26/08

(52) U.S. Cl. CPC G02B 26/0816
USPC 348/80; 359/849

(57) ABSTRACT

A deformable mirror unit 7A including a plurality of segment mirrors 71 each having a surface 71a, a flexible member 72 configured to connect the plurality of segment mirrors 71 to each other, a driver 74 configured to apply a driving force to at least one of the segment mirror 71 and the flexible member 72 so as to change at least one of a position and a tilt of the reflection surface 71a of each of the plurality of segment mirrors 71, and a connector 73 configured to connect the driver 74 to at least one of the segment mirror 71 and the flexible member 72 and to be rotatable so as to change a light reflecting direction by the at least one reflection surface 71a is provided.

### BACKGROUND OF THE INVENTION

1. Field of the Invention

The present invention relates to a mirror unit and an image acquisition unit.

2. Description of the Related Art

A depth of focus of an image acquisition unit which forms a microscopic image of a specimen (a sample) becomes shallower as the resolution becomes higher for a broad field of view. This makes it difficult to focus on the entire surface of an undulate specimen.

Japanese Patent Laid-Open No. (“JP”) 2001-091866 discloses an article which includes a plurality of mechanically and electrically connected mirror elements with deformable reflection surfaces configured to deform so as to deflect a light signal to a target waveguide. The mirror elements are driven by a single actuator. JP 2011-191593 discloses a plurality of segment mirrors, each of which is driven and deformed in three axes by a MEMS.

Assume that a mirror having a reflection surface that can be deformed according to an undulation of a specimen surface is arranged on an optical path of an objective optical system so as to image the specimen on an image sensor via the mirror, and to enable the image sensor to obtain an image focused on the entire surface of the specimen. For instance, in observing an undulate specimen of about 10 μm with an angle of view of approximately 10 mm and at approximately 10-fold magnification, the above mirror needs to significantly deform the reflection surface by about ±1 mm. Each reflection surface described in JP 2001-091866 can provide only a concave surface, and cannot provide a free-curved surface suitable for the surface shape of the specimen. The technology disclosed in JP 2011-191593 would enable each reflection surface to be formed as a free-curved surface, but requires three actuators to drive each segment mirror in three axes, leading to the increase in the size of an image acquisition unit.

### SUMMARY OF THE INVENTION

The present invention provides a small mirror unit that can form a free-curved surface, and an image acquisition unit that can acquire an image focused on an entire surface of an object by using the mirror unit.

A mirror unit according to the present invention includes a plurality of reflectors, each having a reflection surface, a flexible member configured to connect the plurality of reflectors to each other, a driver configured to apply a driving force to at least one of the reflector and the flexible member so as to change at least one of a position and a tilt of the reflection surface of each of the plurality of reflectors, and a connector configured to connect the driver to at least one of the reflector and the flexible member, the connector being rotatable so as to change a light reflecting direction by the at least one reflection surface.

Further features of the present invention will become apparent from the following description of exemplary embodiments with reference to the attached drawings.

### BRIEF DESCRIPTION OF THE DRAWINGS

FIG. 1 is a block diagram of an image acquisition unit according to a first embodiment of the present invention.

FIGS. 2A to 2E are schematic sectional views illustrating examples applicable to a deformable mirror unit illustrated in FIG. 1 according to the first embodiment.

FIGS. 3A to 3D are schematic plan views explaining a method of connecting flexible members illustrated in FIG. 1 according to the first embodiment.

FIGS. 4A and 4B are perspective views illustrating a configuration example applicable to connectors illustrated in FIG. 1 according to the first embodiment.

FIGS. 5A and 5B are views illustrating another configuration example applicable to the connectors illustrated in FIG. 1 according to the first embodiment.

FIG. 6 is a perspective view illustrating a configuration example of the deformable mirror unit illustrated in FIG. 1 according to the first embodiment.

FIGS. 7A to 7D are views illustrating the configuration of the flexible members illustrated in FIG. 6 according to the first embodiment.

FIGS. 8A and 8B are a block diagram of the image acquisition unit and a schematic sectional view illustrating the controller and the deformable mirror unit of the image acquisition unit, respectively, according to a second embodiment of the present invention.

FIGS. 9A and 9B are a block diagram of the image acquisition unit and a schematic sectional view illustrating the controller and the deformable mirror unit of the image acquisition unit, respectively, according to a third embodiment of the present invention.

FIGS. 10A and 10B are a block diagram of the image acquisition unit and a graph explaining a focus adjustment method, respectively according to a fourth embodiment of the present invention.

FIGS. 11A and 11B are a block diagram of the image acquisition unit and a view illustrating an imaging state according to a fifth embodiment of the present invention.

### DESCRIPTION OF THE EMBODIMENTS

A variety of embodiments of the present invention will be described below.

### First Embodiment

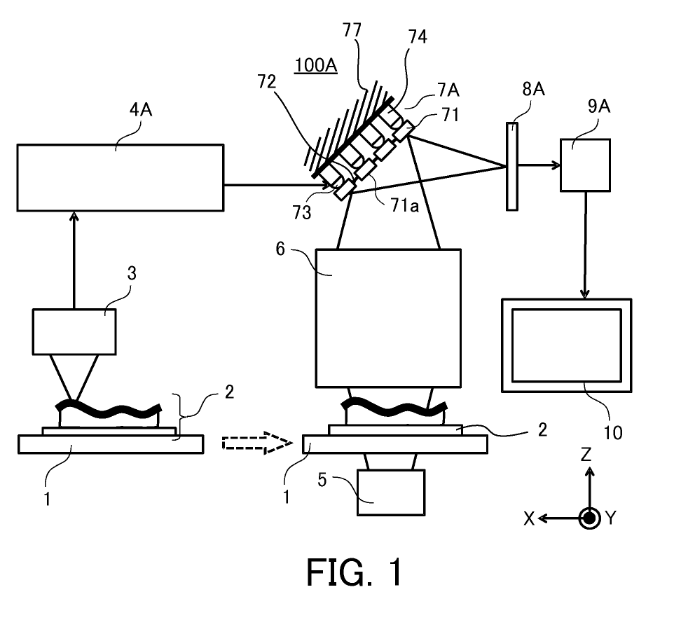

FIG. 1 is a schematic view of principal part of an image acquisition unit 100A according to the first embodiment. The image acquisition unit 100A includes a measurement section and a digital microscope body (an image acquisition unit body). The image acquisition unit of this embodiment is, but not limited to, a digital microscope. The measurement section and the digital microscope body may constitute a single apparatus or separate apparatuses.

First, an object 2 is held on a stage 1 in the measurement section. The object 2, such as a pathological specimen (a sample), is placed on a slide glass and sandwiched by the slide glass and a transparent protector (a cover glass). In FIG. 1, an X-Y plane is a plane perpendicular to a Z axis that is an optical axis of an objective optical system 6, which will be described later. The stage 1 is configured movably in X-, Y-, and Z-axis directions and around each axis.

A measurement unit 3 (a first measurement unit) measures a depth in the Z direction (the Z position of the surface of the object 2) of the held object 2 at each measurement position, and the measurement information is stored in a memory (not illustrated) of a controller 4A via an A/D converter (not illustrated). The measurement unit 3 can utilize, but is not limited to, a commercially available laser displacement unit or Shack-Hartmann sensor.

A control system for the image acquisition unit 100A includes the controller 4A, an image processor 9A, an image display unit 10, the A/D converter (not illustrated), and the memory (not illustrated). The control system for the measurement unit and those for the digital microscope body may be implemented as a single computer or separate computers.

After the measurement is completed, the stage 1 holding the object 2 is moved to the digital microscope body. The digital microscope body includes an illumination unit 5, the stage 1, the objective optical system 6, a deformable mirror unit 7A, an image sensor 8A, the A/D converter, the image processor 9A, and the image display unit 10. In this embodiment, the controller 4A controls the digital microscope body as well.

The illumination unit 5 includes a light source and an illumination optical system. The illumination optical system uniformly illuminates the object 2 with light from the light source. The illumination method may be the epi-illumination that illuminates a specimen from the top and images the reflected light. The object 2 is an object to be observed.

The objective optical system 6 is an imaging optical system configured to form the image of the object 2 on the image plane of the image sensor 8A. The deformable mirror unit 7A deflects light from the objective optical system 6 to the image sensor 8A. A detailed configuration thereof will be described later.

In order to visually identify a cell in the object 2, the objective optical system 6 is required for a high magnification and a high resolving power. While the objective optical system 6 needs a high numerical aperture (“NA”) for the high resolving power, the high NA shallows the depth of focus. Due to the undulation on the surface of the object 2, the image of the object 2 formed by the objective optical system 6 has an undulate shape and the image pickup area contains a defocus portion (outside the depth of field). Therefore, the imaging position of the object 2 formed by the objective optical system 6 needs to coincide with the image pickup plane of the image sensor 8A. In this embodiment, this is achieved by the deformable mirror unit 7A.

The image sensor 8A is a photoelectric conversion element configured to photoelectrically convert the optical image of the object 2 formed by the objective optical system 6. A CCD sensor or a CMOS sensor can be used as the image sensor 8A. The A/D converter (not illustrated) converts an analog signal sent from the image sensor 8A into a digital signal, and outputs the digital signal to the image processor 9A.

The image processor 9A performs various image processing for the digital signal. The image display unit 10 displays the image processed by the image processor 9A. A computer which includes the image processor 9A can display the image on the image display unit 10, store the image in the memory (not illustrated), and communicate image information to an external device via a network such as the Internet (not illustrated). The image acquisition unit 100A allows the image data of the object to be simultaneously observed among multiple persons or to be shared with a remote pathologist.

The deformable mirror unit 7A is placed on an optical path between the objective optical system 6 and the image sensor 8A, and configured to reflect the light from the objective optical system 6 to the image sensor 8A. The deformable mirror unit 7A includes a plurality of segment mirrors 71, a plurality of flexible members 72, one or more connectors 73, and one or more drivers 74. Their numbers are not limited.

The segment mirrors 71 are reflectors, each of which has a reflection surface 71a on its surface configured to receive the light from the objective optical system 6. Each reflection surface 71a reflects the light from the objective optical system 6 to the image sensor 8A. The reflection surface 71a of each segment mirror 71 is, but not limited to, square in this embodiment. The size and shape of some of the segment mirrors 71 may be changed. The array shape of the segment mirrors 71 is also not limited. While an aluminum on which a nickel plate is deposited as its reflection surface 71a can be used, applicable materials are not limited to them.

Each flexible member 72 is arranged between two or more adjacent segment mirrors 71 to connect these segment mirrors 71 to each other. The flexible members 72 may use, but is not limited to, a thin plate spring with a thickness of approximately 0.5 mm and a width of approximately 2 mm (made of aluminum or phosphor bronze) or an elastic member, such as rubber. Each flexible member 72 of this embodiment is attached to a side surface 71c of the segment mirror 71 near the reflection surface 71a but the attachment is not limited to this embodiment.

The connector 73 connect the driver 74 to at least one of the segment mirror 71 and the flexible member 72. In this embodiment, each connector 73 connects one driver 74 to one segment mirror 71 or one flexible member 72. Alternatively, each connector 73 may connect one driver 74 to a plurality of segment mirrors 71, a plurality of flexible members 72, or a combination of the segment mirror 71 and the flexible member 72. As described later, each connector 73 has such a rotatable structure around an axis parallel to the reflection surface 71a that the connector 73 can tilt the reflection surface 71a.

Each driver 74 applies a driving force to at least one of the segment mirror 71 and the flexible member 72 so as to change at least one of the position and the tilt of each of the reflection surfaces 71a of the plurality of segment mirrors 71. In this embodiment, each of the plurality of drivers 74 is a rod member configured to move in a parallel direction in the X-Z plane, protruding from or retreating into a base 77. Each driver 74 moves in one direction and applies the driving force in one direction, and the directions of the driving forces applied by the plurality of drivers 74 are parallel to each other. The one-way movement may be carried out mechanically by a motor, such as a linear supersonic motor or a voice coil motor, and a cam, or electromagnetically by a solenoid valve, or piezo-electrically, but the structure is not limited to this embodiment.

In this embodiment, as the driver 74 and the corresponding connector 73 displace, the position and orientation of the segment mirror 71 or the flexible member 72 connected to the connector 73 changes. Thereby, the deformable mirror unit 7A has a reflection surface shape corresponding to the surface shape of the object 2. The controller 4A calculates a driving amount of each driver 74 based on the measurement result of the measurement unit 3. By forming a reflection surface shape of the deformable mirror unit 7A corresponding to the surface shape of the object 2, an image focused on the entire surface of the object 2 can be formed on the image pickup plane of the image sensor 8A.

According to the technology disclosed in JP 2011-191593 that provides three or more drivers, for example, for two-axis tilting and one-axis direct-acting to each segment mirror, and each drive becomes larger and the digital microscope would become complex if a large deformation is required. On the other hand, this embodiment provides a deformable mirror unit capable of forming free-curved reflection surfaces with a small number of drivers. In other words, where n is the number of segment mirrors, the configuration that provides three drivers to one segment mirror requires 3n drivers, whereas the deformable mirror unit 7A of this embodiment forms a desirable reflection surface shape with fewer than 3n drivers. This embodiment can thus reduce the number of drivers 74 because two or more segment mirrors 71 are connected by the flexible member 72. Since the deformation caused by one driver 74 is applied to the plurality of segment mirrors 71 via the flexible member 72, the number of drivers 74 can be reduced. Even when the reflection surface shape of the deformable mirror unit 7A does not exactly correspond to the surface shape of the object 2, a defocus amount within the depth of focus of the objective optical system 6 can be disregarded and thus an appropriate approximation may be used.

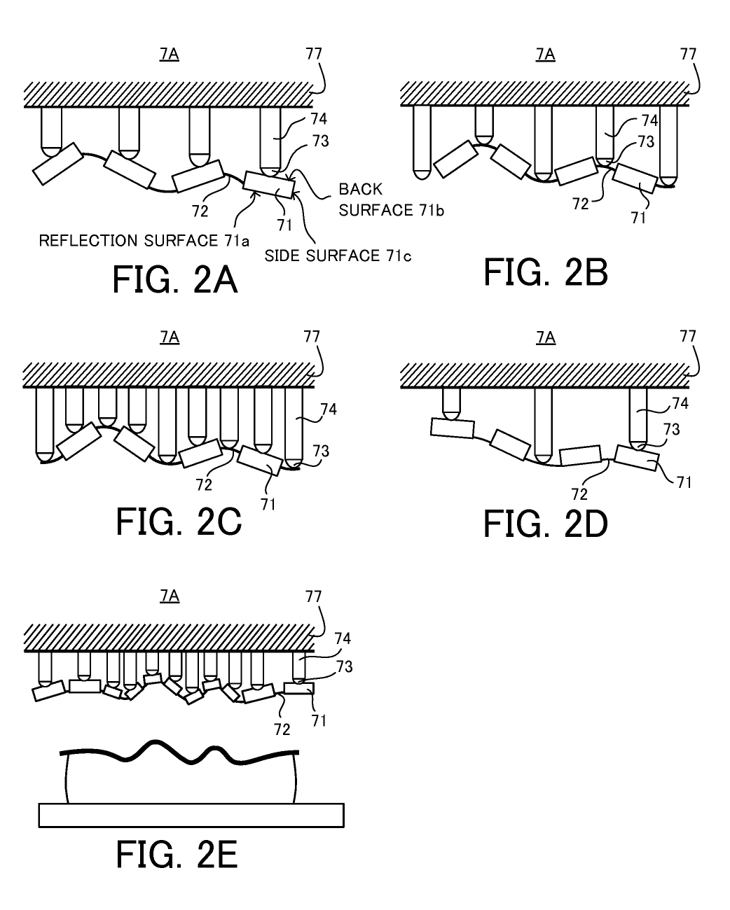

FIGS. 2A-2E are enlarged sectional views on the X-Y plane of deformable mirror units each applicable as the deformable mirror unit 7A illustrated in FIG. 1.

In the deformable mirror unit 7A illustrated in FIG. 2A, each connector 73 is attached to the back surface 71b of a corresponding segment mirror 71, and each flexible member 72 is attached to the side surface 71c of its corresponding segment mirror 71.

In the deformable mirror unit 7A illustrated in FIG. 2B, each connector 73 is attached to the back surface of the corresponding flexible member 72 on the side of the base 77. An interval between two adjacent drivers 74 illustrated in FIG. 2B is approximately the same as that illustrated in FIG. 2A.

In the deformable mirror unit 7A illustrated in FIG. 2C, each connector 73 is attached to either the back surface 71b of the corresponding segment mirror 71 or the back surface of the corresponding flexible member 72 on the side of the base 77. In this case, the connector 73 is classified into a first connector configured to connect the segment mirror 71 to the driver 74, and a second connector configured to connect the flexible member 72 to the driver 74. The number of drivers 74 illustrated in FIG. 2C is twice as large as that illustrated in FIG. 2A, but still smaller than that in the configuration that provides three drivers to each segment mirror.

In the deformable mirror unit 7A illustrated in FIG. 2D, each connector 73 is attached to either the back surface 71b of the corresponding segment mirror 71 or the back surface on the side of the base 77 of the corresponding flexible member 72, but the drivers 74 are thinned out in comparison with those illustrated in FIG. 2C. In other words, where n is the number of segment mirrors 71 and m is the number of flexible members 72, the number drivers 74 is smaller than m+n.

The deformable mirror unit 7A illustrated in FIG. 2E is configured so that each segment mirrors 71 at the center is smaller than that at the periphery for the object 2 that has a larger undulation at or near the surface center and a smaller undulation at the periphery. In other words, in FIG. 2E, there are a plurality of segment mirrors (first reflectors) with a density arranged at the periphery, each having a first reflection surface and a plurality of segment mirrors (second reflectors) with a density higher than that of the first reflectors at the center, each having a second reflection surface which is smaller than the first reflection surface. Thereby, the reflection surface shape at the center can precisely reflect the surface shape of the object 2.

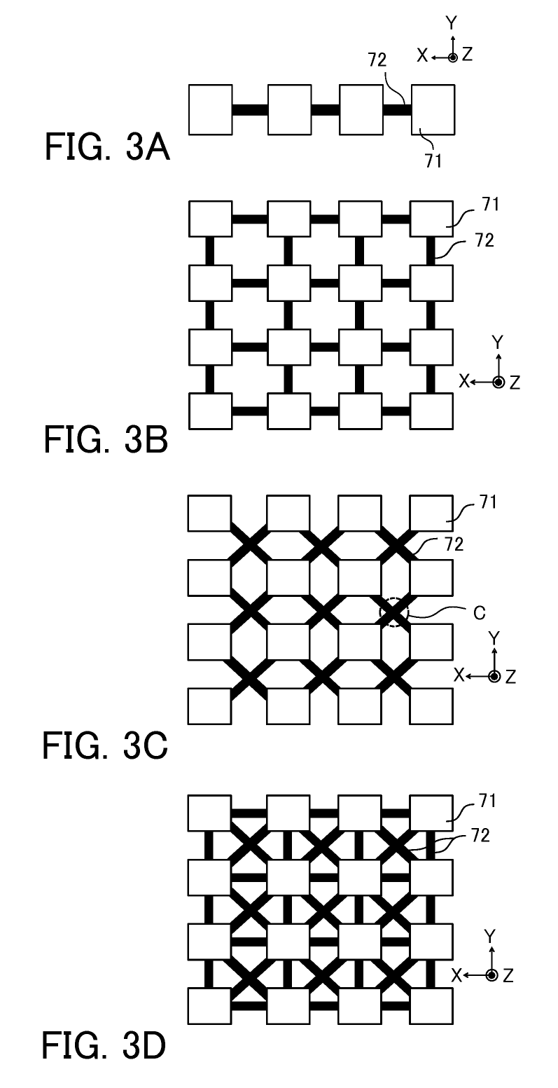

FIGS. 3A to 3D are schematic plan views for explaining a method of connecting the flexible members 72.

The example illustrated in FIG. 3A arranges the plurality of segment mirrors 71 in the X-axis direction (linear array), and connects two adjacent segment mirrors 71 using one flexible member 72. The array illustrated in FIG. 3A is effective when the undulation of the surface of the object 2 distributes in the X-axis direction, and is moderate in the Y-axis direction. The image sensor 8A use a line sensor. While FIG. 3A illustrates the segment mirrors 71 arranged in the X-axis direction, an array in the Y-axis direction is also applicable.

The example illustrated in FIG. 3B arranges the plurality of segment mirrors 71 in the X-axis direction and the Y-axis direction (two-dimensional array), and connects two adjacent segment mirrors 71 using one flexible member 72. The array illustrated in FIG. 3B is effective when the undulation of the surface of the object 2 two-dimensionally distributes. In this case, there are first flexible members arranged in the X-axis direction (the first direction) and second flexible members arranged in the Y-axis direction (the second direction).

The example illustrated in FIG. 3C arranges the plurality of segment mirrors 71 in the X-axis direction and the Y-axis direction (two-dimensional array) similar to FIG. 3B. Different from FIG. 3B, two diagonally adjacent segment mirrors 71 are connected by one flexible member 72, and two flexible members 72 extending in different diagonal directions crosses at a corresponding intersection C. In other words, each flexible member 72 is a third flexible member arranged so that it tilts relative to each of the X-axis direction and the Y-axis direction. The array illustrated in FIG. 3C is effective when the undulation of the surface of the object 2 two-dimensionally distributes. When the driver 74 drives the intersection C, the plurality of segment mirrors 71 can be driven with the drivers 74 fewer than the total number of segment mirrors. For instance, n×m segment mirrors 71 arranged in this manner of this embodiment can be driven by L drivers 74 where L<n×m is satisfied. One cross-shaped flexible member 72 may be used instead of two flexible members 72 crossing at the corresponding intersection C.

The example illustrated in FIG. 3D is the combination of the connection methods illustrated in FIGS. 3B and 3C. The array illustrated in FIG. 3D is effective when the undulation of the surface of the object 2 two-dimensionally distributes.

In FIGS. 3A to 3D, the plurality of segment mirrors 71 is arranged like a matrix in the one-dimensional or two-dimensional array. In the linear array, the plurality of segment mirrors 71 are arranged in the row or column direction. In the two-dimensional array, the plurality of segment mirrors 71 are arranged in the row and column directions. The array of the plurality of segment mirrors 71, however, is not limited to this embodiment. For instance, the two-dimensional array may be checkered, in which lateral positions of the segment mirrors 71 at the first and third rows shift from the lateral positions of the segment mirrors 71 at the second and fourth rows.

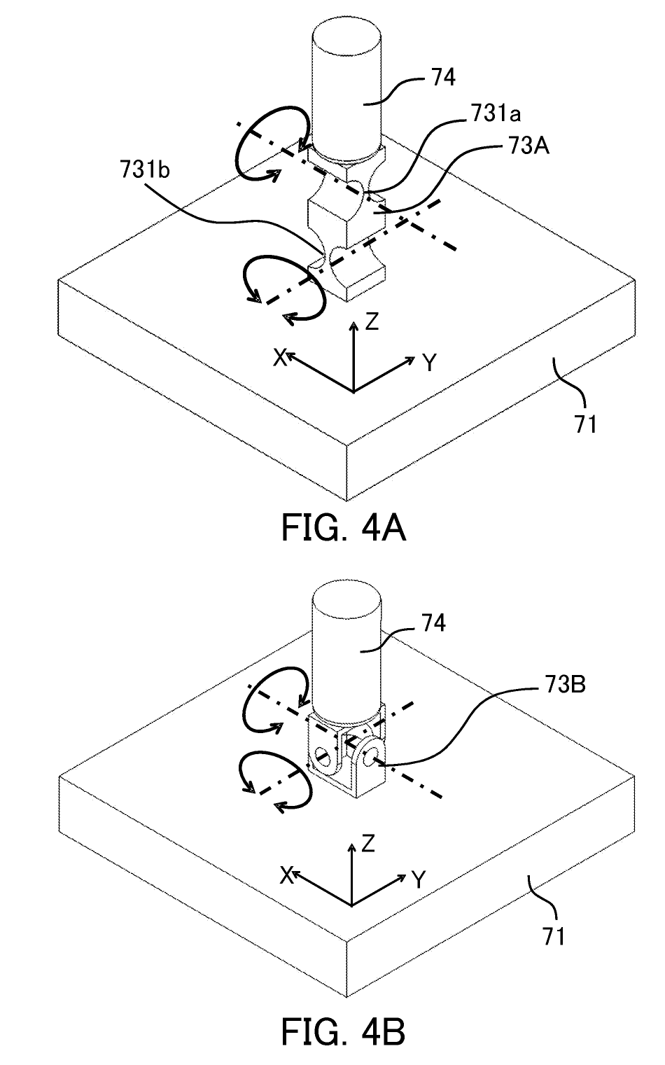

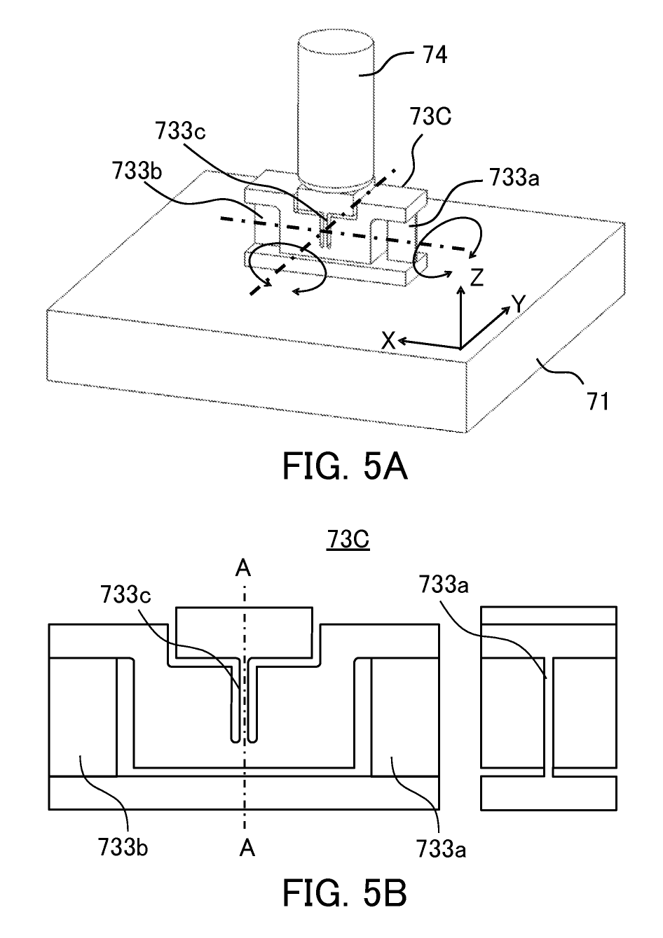

FIGS. 4A, 4B, 5A, and 5B illustrate configuration examples applicable to the connector 73 illustrated in FIG. 1. As described with reference to FIGS. 3A to 3D, the plurality of segment mirrors 71 are arranged in the one-dimensional or two-dimensional array. In the one-dimensional array illustrated in FIG. 3A, as the driver 74 is driven, the segment mirror 71 rotates around an axis parallel to the Y axis orthogonal to the array direction of the segment mirrors 71 and the connector 73 is accordingly required to rotate around the axis parallel to the Y axis. On the other hand, in the two-dimensional arrays illustrated in FIGS. 3B to 3D, as the driver is driven 74, the segment mirror 71 rotates around the axis parallel to the X axis and around the axis parallel to the Y axis. Accordingly, the connector 73 is required to rotate around the axis parallel to the Y axis and around the axis parallel to the Y axis. The light reflecting direction by the reflection surface 71a changes when the connector 73 rotates around any one of these two rotating axes, i.e., the X axis and the Y axis.

FIG. 4A is a perspective view illustrating a connector 73A rotatable around each of two orthogonal axes. The connector 73A includes two flexible hinges (a first flexible hinge 731a and a second flexible hinge 731b). The first flexible hinge 731a rotates around the axis parallel to the X axis that is one of the two rotating axes, and thus has a pair of notches having a (first) arc-shaped section on the Y-Z plane (a first plane). The second flexible hinge 731b rotates around the axis parallel to the Y axis that is the other of the two rotating axes, and thus has a pair of notches having a (second) arc-shaped section on the X-Z plane (a second plane). The overlapping of the first flexible hinge 731a and the second flexible hinge 731b in the Z-axis direction vertical to both of these two rotating axes reduces the area of the connector 73A on the X-Y plane.

FIG. 4B is a perspective view illustrating a connector 73B rotatable around each of two orthogonal axes. The connector 73B includes a universal joint, and is rotatable around an axis parallel to the X axis and around an axis parallel to the Y axis. The universal joint may contain two rotating kinematic elements, such as a rolling or sliding element. When the θz rotation is permissible, a ball kinematic element is applicable.

FIG. 5A is a perspective view illustrating a connector 73C rotatable around each of two orthogonal axes. FIG. 5B is a front view illustrating the detail of the connector 73C. The connector 73C includes first flexible hinges 733a and 733b which rotate around an axis parallel to the X axis, and a second flexible hinge 733c which rotates around an axis parallel to the Y axis. The first flexible hinges 733a and 733b are located on the same plane, and thus have the same rotating axis. The rotating axis of the first flexible hinges 733a and 733b, and that of the second flexible hinge 733c cross at one point. Thus, similar to the universal joint, rotations both around the axis parallel to the X axis and around the axis parallel to the Y axis are available. The connector 73C can be shaped into one unit, for example, through wire cutting or mill cutting. An applicable shape of the connector 73C, however, is not limited to this embodiment, and the connector 73C may be shaped into two units, one serving to rotate around the X axis and the other serving to rotate around the Y axis.

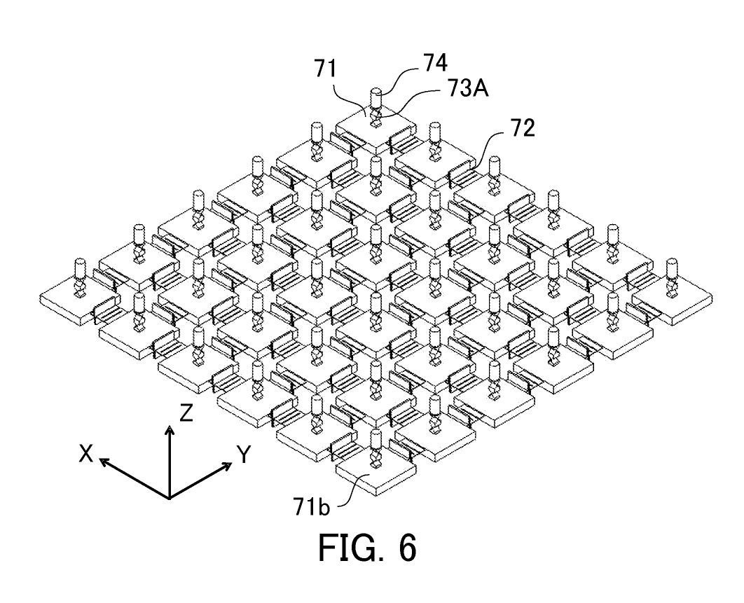

FIG. 6 is a perspective view illustrating a configuration example of the deformable mirror unit 7A. In FIG. 6, the segment mirrors 71 are two-dimensionally arrayed at regular intervals, and are connected to each other by the flexible members 72 as illustrated in FIG. 3B. On the back surface 71b of each segment mirror 71, the connector 73 and the driver 74 illustrated in FIG. 4A are provided and connected as illustrated in FIG. 2A. Since the segment mirror 71 rotates around the X axis and the Y axis, the flexible member 72 is twisted, bent, extended, or shrunk. Hence, in order to maintain the driving of the segment mirrors 71, the flexible member 72 needs to be extendable in the direction (s) in which the segment mirrors 71 are arranged and to be rotatable around each of the X axis and the Y axis.

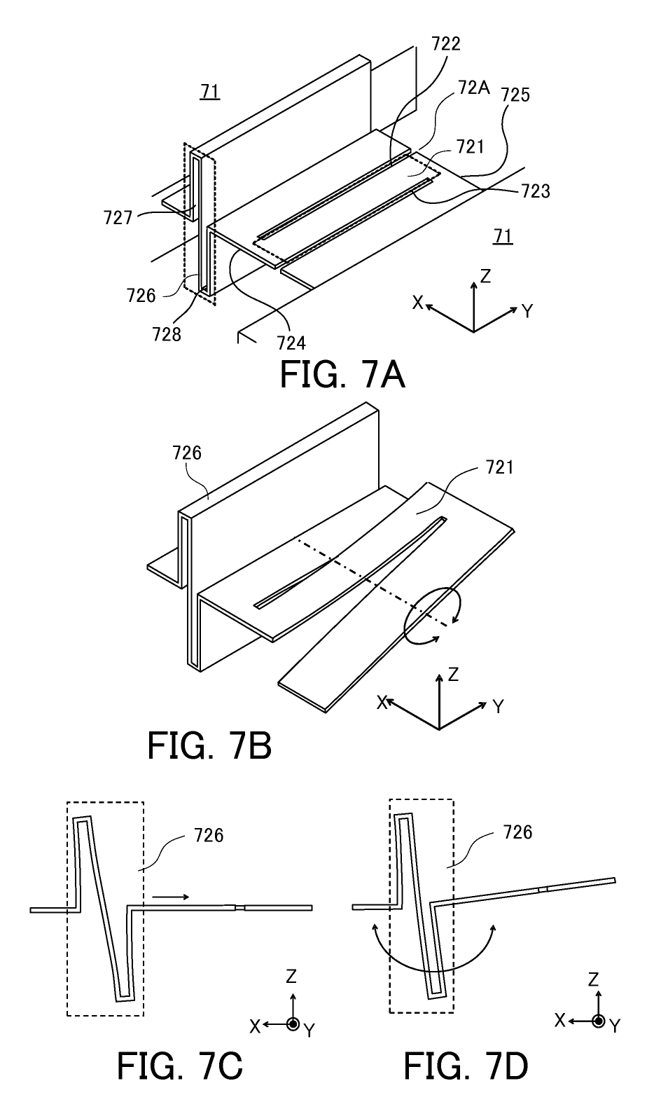

FIG. 7A is a perspective view illustrating a configuration example of a flexible member 72A applicable to each flexible member 72 illustrated in FIG. 6. As illustrated in FIG. 7A, the flexible member 72A includes a (third) flexible hinge 721 and a (fourth) flexible hinge 726.

The flexible hinge 721 is a flat plate with cuts 722 and 723, which is parallel to the X-Y plane. The flexible hinge 721 has one end connected to the flexible hinge 726 and the other end connected to the segment mirror 71 on the front side of FIG. 7A. Each of the cuts 722 and 723 extends parallel to the Y-axis direction. The cut 722 extends from a position that is a predetermined distance apart from the side surface 724, to the side surface 725 of the segment mirror 71. The cut 723 extends from a position that is a predetermined distance apart from the side surface 725, to the side surface 724 of the segment mirror 71. In other words, the cuts 722 and 723 alternate with each other and extend parallel to the Y-axis direction, whereby the flexible hinge 721 is formed as an approximately S-shaped thin plate.

FIG. 7B is a perspective view illustrating the elastic deformation of the flexible hinge 721. The flexible hinge 721 is a thin plate that extends in the Y-axis direction and thus is likely to bend around the X axis as illustrated. Therefore, the flexible member 72A can rotate around the X axis. The number of cuts is not limited to two.

The flexible hinge 726 has a bellows structure in which a plurality of thin Y-Z plates are connected to each other. The flexible hinge 726 has one end connected to the flexible hinge 721, and the other end connected to the segment mirror 71 at the back of FIG. 7A. The flexible hinge 726 has two bends such that the section on the X-Y plane of the thin plate forms an S shape. The number of bends is not limited to this embodiment. Two grooves created by the bends alternate with each other: One groove 727 opens in the -Z-axis direction from the elastic hinge 721, and the other groove 728 opens in the +Z-axis direction.

FIGS. 7C and 7D are sectional views illustrating the elastic deformations of the flexible hinge 726. As illustrated in FIG. 7C, the bellows structure of the flexible hinge 726 allows the plurality of thin plates to bend, and the associating deformations entirely provide the extension or shrinkage in the X-axis direction. Thereby, the flexible member 72A is extendable in the direction in which the segment mirrors 71 are arranged (the X-axis direction as illustrated). As illustrated in FIG. 7D, the flexible hinge 726 is a thin plate that extends in the Z-axis direction, and thus likely to bend in the Y-axis direction. Therefore, the flexible member 72A becomes rotatable around the Y axis.

As described above, the flexible member 72A is extendable in the direction in which the segment mirrors 71 are arranged and rotatable around the X axis and the Y axis. The flexible member 72A is, of course, applicable to the configurations illustrated in FIGS. 2B to 2E.

### Second Embodiment

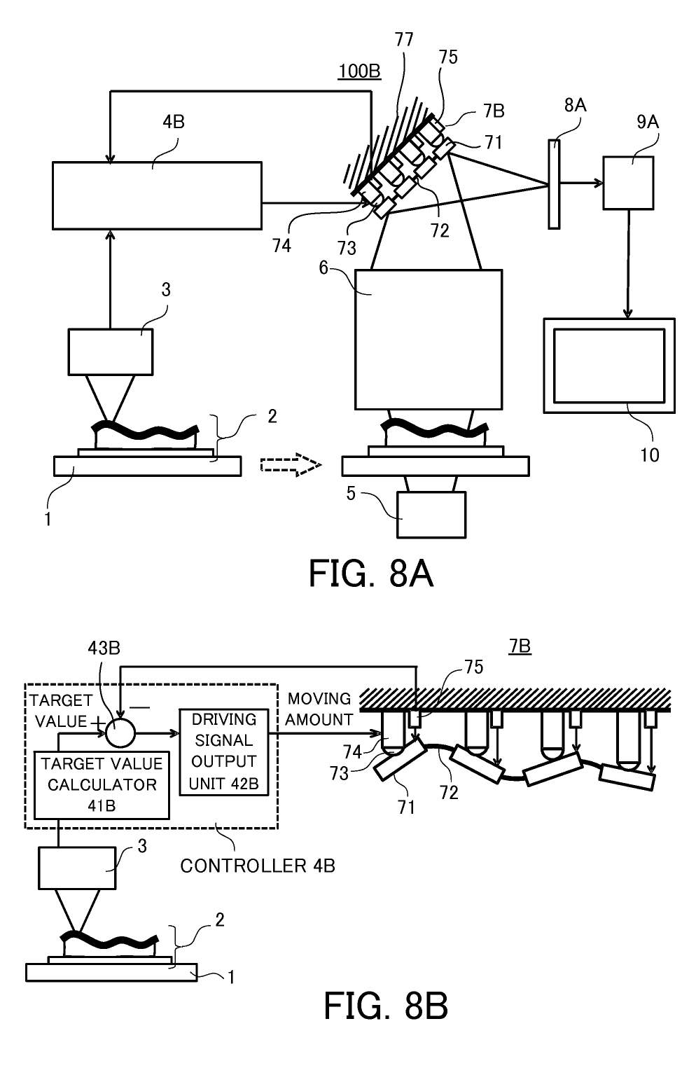

FIG. 8A is a schematic view of principal part of an image acquisition unit 100B according to a second embodiment. Those elements, which are the corresponding elements illustrated in FIG. 1, are designated by the same reference numerals. While the image acquisition unit 100B includes a control system, it is different from the image acquisition unit 100A in that it includes a controller 4B instead of the controller 4A and a deformable mirror unit instead of the deformable mirror unit 7A.

As the driver 74 displaces with the corresponding connector 73, the segment mirror 71 or the flexible member 72 changes a position or an orientation and the deformable mirror unit 7B has a reflection surface shape corresponding to the surface shape of the object 2 similar to the first embodiment. In this embodiment, a driving amount of the driver 74 is equal to a moving amount (a displacement amount) of the driver 74. Similarly, the controller 4B calculates the moving amount of the driver 74 based on the measurement results of the measurement unit 3. By forming a reflection surface shape of the deformable mirror unit 7B corresponding to the surface shape of the object 2, an image focused on the entire surface of the object 2 is formed on the imaging surface of the image sensor 8A.

FIG. 8B illustrates the detailed configurations of the controller 4B and the deformable mirror unit 7B. As illustrated, the deformable mirror unit 7B includes a plurality of segment mirrors 71, a plurality of flexible members 72, one or more connectors 73, and one or more drivers 74, similar to the deformable mirror unit 7A. Therefore, the deformable mirror unit 7B can use the configuration of the first embodiment. Since the deformable mirror unit 7B also connects two or more segment mirrors 71 with each other using the flexible member 72, the number of drivers 74 is smaller than that described in JP 2011-191593.

The deformable mirror unit 7B further includes a plurality of (second) measurement units 75. One measurement unit 75 is provided to each segment mirror. Each measurement unit 75 measures at least one of the position and the tilt of the corresponding segment mirror 71. Each measurement unit 75 may include, but is not limited to, a laser displacement unit, an electrostatic capacity sensor, a linear scale, or the like. The measurement result of the measurement unit 75 is sent to the controller 4B.

The controller 4B includes a target value calculator 41B, a driving signal output unit 42B, and a comparator 43B. The target value calculator 41B calculates target values of the position and the angle of each segment mirror 71 (or a target value of the moving amount of each driver 74) based on the measurement result of the measurement unit 3. The comparator 43B compares the measurement result of each measurement unit 75 with the target values calculated by the target value calculator 41B and outputs a comparison result to the driving signal output unit 42B. The driving signal output unit 42B transmits, based on the comparison result, a signal indicating a moving amount to the driver 74. A feedback control configured to reduce a difference between the target value and the measurement result can more precisely adjust a mirror position.

For control of using a position measurement value, a method that does not directly detect a position control amount, such as a control of a driving pulse number of a pulse motor, is applicable as a multi-function unit that substantially serve as a position measuring unit and a position controller.

### Third Embodiment

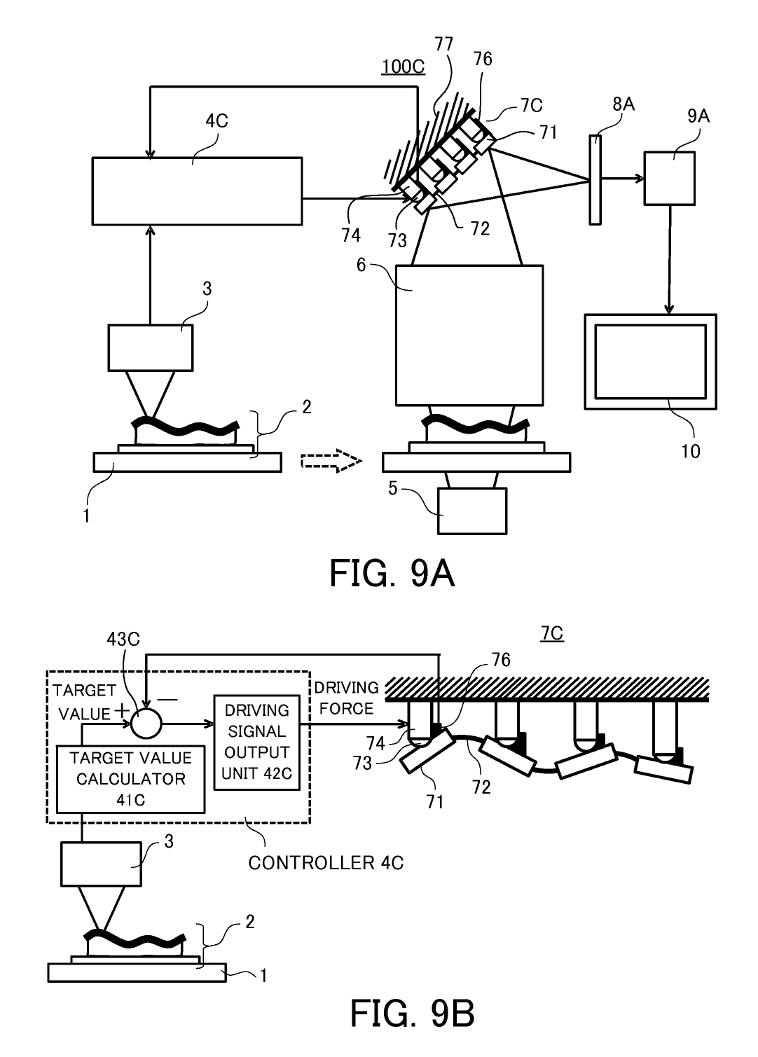

FIG. 9A is a schematic view of principal part of an image acquisition unit 100C according to a third embodiment. Those elements, which are the corresponding elements illustrated in FIG. 1, are designated by the same reference numerals. The image acquisition unit 100C is different from the image acquisition unit 100B in that it includes a controller 4C instead of the controller 4A and a deformable mirror unit 7C instead of the deformable mirror unit 7A.

As the driver 74 displaces with the corresponding connector 73, the segment mirror 71 or the flexible member 72 changes a position or an orientation and the deformable mirror unit 7C has a reflection surface shape corresponding to the surface shape of the object 2, similar to the first embodiment. In this embodiment, a driving amount of the driver 74 is a driving amount which the driver 74 gives to the segment mirror 71 or the flexible members 72. Similarly, the controller 4C calculates the moving amount of the driver 74 based on the measurement result of the measurement unit 3. By forming a reflection surface shape of the deformable mirror unit 7C corresponding to the surface shape of the object 2, an image focused on the entire surface of the object 2 is formed on the imaging surface of the image sensor 8A.

FIG. 9B illustrates the detailed configurations of the controller 4C and the deformable mirror unit 7C. As illustrated, the deformable mirror unit 7C includes a plurality of segment mirrors 71, a plurality of flexible members 72, one or more connectors 73, and one or more drivers 74, similar to the deformable mirror unit 7A. Therefore, the deformable mirror unit 7C can use the configurations of the first embodiment. Since the deformable mirror unit 7C also connects two or more segment mirrors 71 with each other using the flexible member 72, the number of drivers 74 is smaller than that described in JP 2011-191593.

The deformable mirror unit 7C further includes a plurality of (third) measurement units 76. One measurement unit 76 is provided to each segment mirror 71. Each measurement unit 76 measures a driving force given by each driver 74. Each measurement unit 76 may include, but is not limited to, a load cell that applied a strain gauge, a crystal piezoelectric system, or the like. The measurement result of the measurement unit 76 is sent to the controller 4C.

The controller 4C includes a target value calculator 41C, a driving signal output unit 42C, and a comparator 43C. The target value calculator 41C calculates a target value of a driving force generated by each driver 74 based upon the measurement result of the measurement unit 3. The comparator 43C compares the measurement result of each measurement unit 76 with the target value calculated by the target value calculator 41C and outputs a comparison result to the driving signal output unit 42C. The driving signal output unit 42C transmits, based on the comparison result, a signal indicating a moving amount to the driver 74. A feedback control configured to reduce a difference between the target value and the measurement result can more precisely adjust a mirror position.

In force control using a measured force value, a method that does not directly detect a control amount, such as a VCM current control and an inner pressure control of an air cylinder, is applicable as a multi-function unit that substantially serves as a force measurement unit and a force controller. Alternatively, a change from passive prismatic pair to an active prismatic pair, such as a guided VCM and an air cylinder.

A feedback control method that uses both control methods according to the second and third embodiments and employs both the measured position value and the measured force value.

### Fourth Embodiment

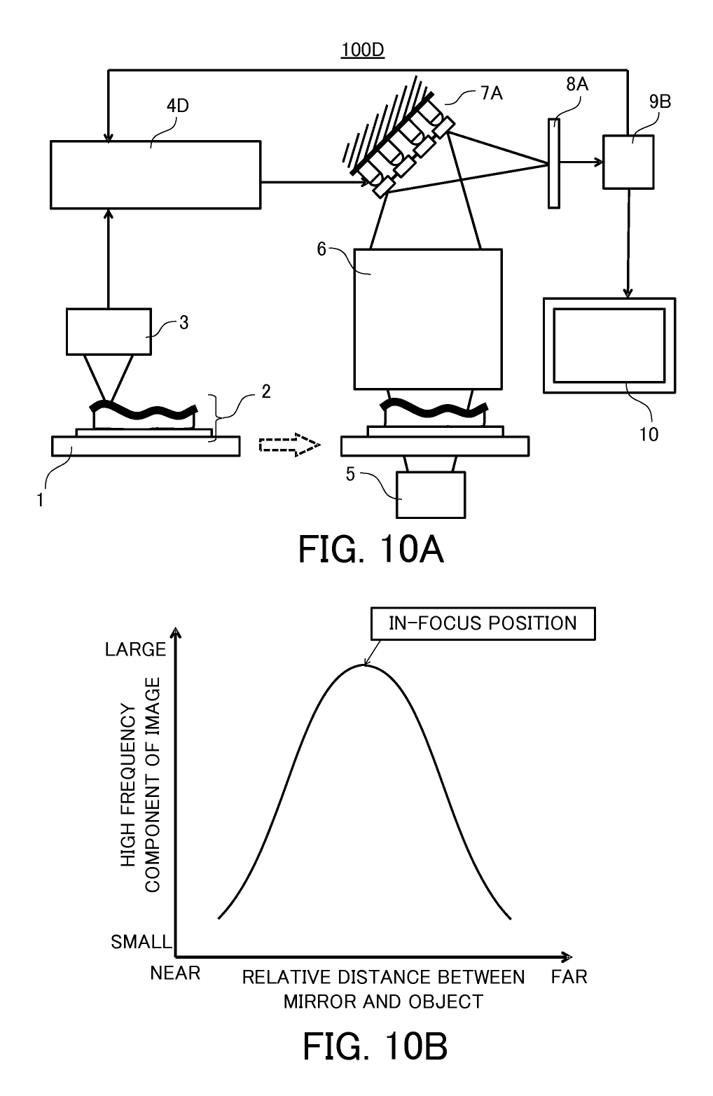

FIG. 10A is a schematic view of principal part of an image acquisition unit 100D according to a fourth embodiment. Those elements, which are the corresponding elements illustrated in FIG. 1, are designated by the same reference numerals. The image acquisition unit 100D is different from the image acquisition unit 100A in that it uses a controller 4D instead of the controller 4A and an image processor 9B instead of the image processor 9A.

As the driver 74 displaces with the corresponding connector 73, the segment mirror 71 or the flexible member 72 changes a position or an orientation and the deformable mirror unit 7A has a reflection surface shape corresponding to the surface shape of the object 2. The controller 4D calculates a driving amount of the driver 74 based on the measurement result of the measurement unit 3. By forming a reflection surface shape of the deformable mirror unit 7A corresponding to the surface shape of the object 2, an image focused on the entire surface of the object 2 is formed on the imaging surface of the image sensor 8A. Since the deformable mirror unit 7A connects two or more segment mirrors 71 with each other using the flexible member 72, the number of drivers 74 is smaller than that described in JP 2011-191593.

The fourth embodiment performs a feedback control by calculating a driving amount of the segment mirror 71 of the deformable mirror unit 7A based upon an image signal generated by the image sensor 8A. One example will be described below.

FIG. 10B is a graph illustrating a relationship between the relative distance (abscissa axis) between the segment mirror 71 and the object 2, and the high frequency component of the image signal (ordinate axis). As illustrated, since the high frequency component of the image signal peaks at an in-focus position, the high component of the image signal is used as a focus evaluation value to determine whether or not the object 2 is focused. The image processor 9B calculates a focus evaluation value from the image signal obtained from the image sensor which corresponds to a photoelectrical conversion of the object image, and sends the calculated value to the controller 4D. The controller 4D controls the segment mirrors 71 such that the calculated focus evaluation value peaks. Thereby, the focused image can be obtained.

### Fifth Embodiment

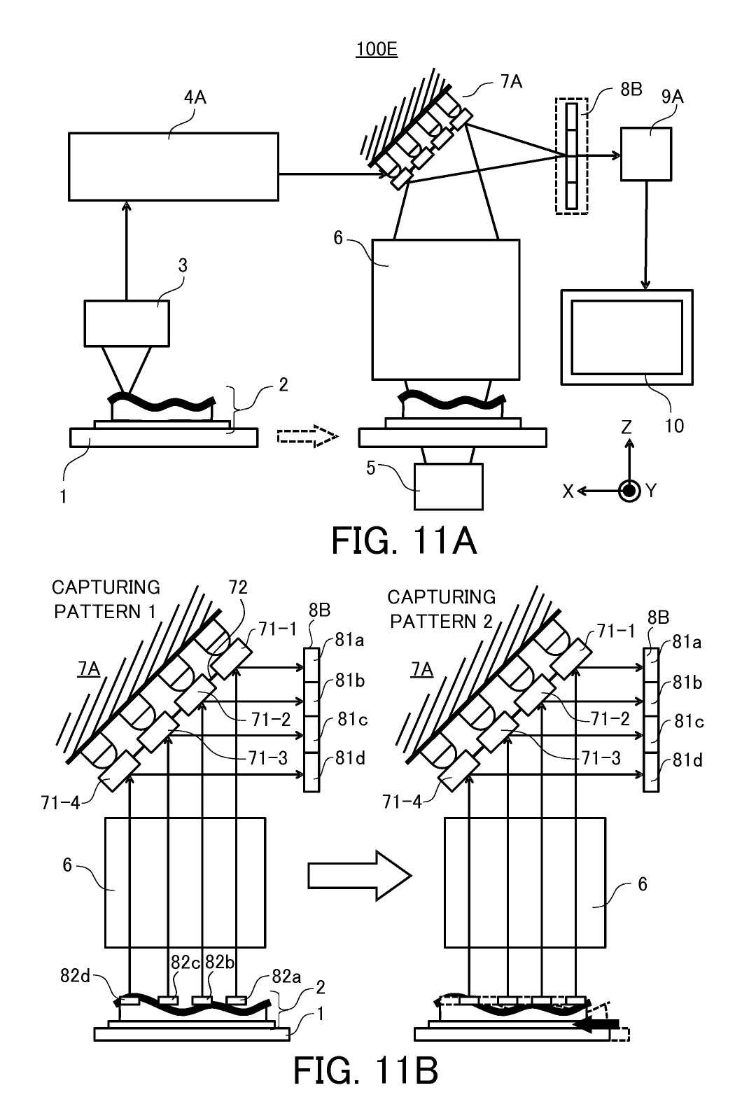

FIG. 11A is a schematic view of principal part of an image acquisition unit 100E according to a fifth embodiment. Those elements, which are the corresponding elements illustrated in FIG. 1, are designated by the same reference numerals. The image acquisition unit 100E is different from the image acquisition unit 100A in that it uses an image sensor 8B instead of the image sensor 8A.

As the driver 74 displaces with the corresponding connector 73, the segment mirror 71 or the flexible member 72 changes a position or an orientation and the deformable mirror unit 7A has a reflection surface shape corresponding to the surface shape of the object 2. The controller 4A calculates a driving amount of the driver 74 based on the measurement result of the measurement unit 3. By forming a reflection surface shape of the deformable mirror unit 7A corresponding to the surface shape of the object 2, an image focused on the entire surface of the object 2 is formed on the imaging surface of the image sensor 8A. Since the deformable mirror unit 7A connects two or more segment mirrors 71 with each other using the flexible member 72, the number of drivers 74 is smaller than that described in JP 2011-191593.

FIG. 11B illustrates an image pickup state according to the fifth embodiment. The image sensor 8B includes a plurality of photoelectric converters 81a, 81b, 81c, and 81d. The number of photoelectric converters is not limited.

The photoelectric converter 81a receives light from an image pickup area 82a of the object 2 which is reflected by a segment mirror 71-1. The photoelectric converter 81b receives light from an image pickup area 82b of the object 2 which is reflected by a segment mirror 71-2. The photoelectric converter 81c receives light from an image pickup area 82c of the object 2 which is reflected by a segment mirror 71-3. The photoelectric converter 81d receives light from an image pickup area 82d of the object 2 which is reflected by a segment mirror 71-4.

In the deformable mirror unit 7A, projection light of the object 2 which passes through the objective optical system 6 is not reflected in the region where there are the flexible members 72. In other words, the object 2 is captured not wholly but partially (image pickup pattern 1). In FIG. 11B, the image pickup areas 82a, 82b, 82c, and 82d spaced from each other describe this situation. In order to capture the entire area of the object 2, the position of the object 2 is changed by the stage 1 so as to capture the uncaptured area of the object 2 (image pickup pattern 2).

In the imaging pattern 2 illustrated in FIG. 11B, rectangles illustrated by broken lines on the surface of the object 2 represent the image pickup areas 82a, 82b, 82c, and 82d in the imaging pattern 1. Rectangles illustrated by solid lines represent the image pickup areas 82a, 82b, 82c, and 82d in the imaging pattern 2. By combining the image pickup areas in the imaging patterns 1 and 2, the entire area of the object 2 can be captured, the image processor 9A superimposes an image signal obtained in the imaging pattern 1 onto an image signal obtained in the imaging pattern 2. In other words, the image sensor captures the object 2 multiple times by changing the positions of the object 2 and the objective optical system 6 in the direction perpendicular to the optical axis, and the image processor 9A superimposes image signals obtained from the image sensor through multiple captures.

In FIGS. 11A and 11B, a method of forming an image by moving the stage 1 once in the X-axis direction is described but the moving method is not limited to this example such as moving in the Y-axis direction. The number of movements may be one or more. The photoelectric converter array may not be limited to the Z-axis direction illustrated in FIG. 11B, but may be directed in the Y-axis direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For instance, the present invention is applicable to an image pickup apparatus, such as a digital camera and a telescope, configured to capture an image formed by the image sensor and derived from an optical image of the object through the optical system.

A reimaging optical system may be provided on an optical path between the mirror unit and the image sensor so as to condense light reflected by the mirror unit, on the image pickup plane of the image sensor. In other words, the optical image of the object formed by the objective optical system may be re-imaged by the reimaging optical system.

The image acquisition unit according to the present invention is not limited to a microscope configured to magnify an object for observations using an objective optical system as a magnification system, and is useful, for example, for an inspection apparatus used for a visual inspection of a substrate and the like (so as to find an adhesion of foreign matters and scratches).

The present invention can thus provide a small mirror unit configured to form a free-curved surface, and an image acquisition unit configured to acquire an image focused on the entire surface of an object by using the mirror unit.

The present invention is applicable to a digital microscope, a digital camera, a telescope, and the like.

This application claims the benefit of Japanese Patent Application No. 2013-031474, filed on Feb. 20, 2013, which is hereby incorporated by reference herein in its entirety.

What is claimed is:

1. A mirror unit comprising:
a plurality of reflectors, each having a reflection surface;
a flexible member configured to connect the plurality of reflectors to each other;
a driver configured to apply a driving force to at least one of the reflector and the flexible member so as to change at least one of a position and a tilt of the reflection surface of each of the plurality of reflectors; and
a connector configured to connect the driver to at least one of the reflector and the flexible member, the connector being rotatable so as to change a light reflecting direction by the at least one reflection surface.

2. The mirror unit according to claim 1, wherein the number of drivers is smaller than 3n where n is the number of reflectors.

3. The mirror unit according to claim 1, wherein the driver is configured to apply the driving force in one direction.

4. The mirror unit according to claim 3, wherein the driver moves in the one direction.

5. The mirror unit according to claim 1, further comprising a plurality of drivers, wherein directions of a plurality of driving forces applied by the plurality of drivers are parallel to each other.

6. The mirror unit according to claim 1, wherein the connector includes a first connector configured to connect the reflector to the driver, and a second connector configured to connect the flexible member to the driver.

7. The mirror unit according to claim 6, wherein the number of drivers is smaller than m+n where n is the number of reflectors and m is the number of flexible members.

8. The mirror unit according to claim 1, wherein the plurality of reflectors include a plurality of first reflectors, each having a first reflection surface, and a plurality of second reflectors, each having a second reflection surface smaller than the first reflection surface, and
wherein a density of the second reflectors is higher than that of the first reflectors.

9. The mirror unit according to claim 1, wherein the plurality of reflectors and the flexible member are linearly arrayed, and
wherein the connector is rotatable around an axis parallel to a direction orthogonal to an array direction of the reflectors.

10. The mirror unit according to claim 1, wherein the connector is rotatable around two rotating axes which are not parallel to each other, and
wherein the light reflecting direction by the at least one reflection surface changes when the connector rotates around any one of the two rotating axes.

11. The mirror unit according to claim 10, wherein the plurality of reflectors are two-dimensionally arrayed in a first direction and a second direction which is orthogonal to the first direction, and
wherein the connector is rotatable around each of an axis parallel to the first direction and an axis parallel to the second direction.

12. The mirror unit according to claim 11, wherein the flexible member includes a first flexible member arranged in the first direction, and a second flexible member arranged in the second direction.

13. The mirror unit according to claim 11, wherein the flexible member includes a third flexible member arranged in a direction tilted to each of the first direction and the second direction.

14. The mirror unit according to claim 1, wherein the connector is a flexible hinge.

15. The mirror unit according to claim 14, wherein the connector is rotatable around each of two rotating axes which are orthogonal to each other,
wherein the light reflecting direction by the at least one reflection surface changes when the connector rotates around any one of the two rotating axes, and
wherein the connector includes a first flexible hinge with a first arc-shaped notch used to rotate around one of the two rotating axes, and a second flexible hinge with a second arc-shaped notch used to rotate around the other of the two rotating axes, the first flexible hinge and the second flexible hinge overlapping each other in a direction of an axis vertical to both of the two rotating axes.

16. The mirror unit according to claim 14, wherein the connector is rotatable around each of the two rotating axes which are orthogonal to each other,
wherein the light reflecting direction by the at least one reflection surface changes when the connector rotates around any one of the two rotating axes, and
wherein the connector includes a first flexible hinge used to rotate around one of the two rotating axes, and a second flexible hinge used to rotate around the other of the two rotating axes, the two rotating axes cross at one point.

17. The mirror unit according to claim 1, wherein the connector is a universal joint.

18. The mirror unit according to claim 1, wherein the flexible member is extendable in an array direction of the plurality of reflectors, and rotatable around an axis parallel to the array direction of the plurality of reflectors and around an axis vertical to the array direction of the plurality of reflectors.

19. The mirror unit according to claim 18, wherein the flexible member includes a third flexible hinge configured to rotate around one of two rotating axes, and a fourth flexible hinge configured to rotate around the other of the two rotating axes, the fourth flexible hinge being extendable.

20. The mirror unit according to claim 19,
wherein the third flexible hinge includes a flat thin plate parallel to the two rotating axes, the thin plate having a cut parallel to the one of the two rotating axes, and
wherein the fourth flexible hinge includes thin plates forming a bellows structure.

21. An image acquisition unit comprising:
an imaging optical system configured to form an optical image of an object;
an image sensor configured to photoelectrically convert the optical image of the object formed by the imaging optical system; and
a mirror unit, arranged on an optical path between the imaging optical system and the image sensor, and configured to reflect light from the imaging optical system to the image sensor,
wherein the mirror unit includes:
a plurality of reflectors, each having a reflection surface;
a flexible member configured to connect the plurality of reflectors to each other;
a driver configured to apply a driving force to at least one of the reflector and the flexible member so as to change at least one of a position and a tilt of the reflection surface of each of the plurality of reflectors; and
a connector configured to connect the driver to at least one of the reflector and the flexible member, the connector being rotatable so as to change a light reflecting direction by the at least one reflection surface.

22. The image acquisition unit according to claim 21, further comprising:
a first measurement unit configured to measure a surface shape of the object; and
a controller configured to control the driver such that the plurality of reflection surfaces of the plurality of reflectors correspond to the surface shape of the object measured by the first measurement unit.

23. The image acquisition unit according to claim 22, further comprising a second measurement unit configured to measure at least one of the position and the tilt of each of the plurality of reflectors of the mirror unit,
wherein the controller feedback-controls the driver based on a measurement result by the second measurement unit.

24. The image acquisition unit according to claim 22, further comprising a third measurement unit configured to measure the driving force applied by the driver,
wherein the controller feedback-controls the driver based on a measurement result of the third measurement unit.

25. The image acquisition unit according to claim 22, further comprising an image processor configured to process an image signal obtained from the image sensor,
wherein the controller feedback-controls the driver such that a high frequency component in the image signal obtained from the image processor peaks.

26. The image acquisition unit according to claim 22, further comprising the image processor configured to process an image signal obtained from the image sensor,
wherein the image sensor captures the object multiple times by changing a position in a direction vertical to an optical axis of the imaging optical system, and
wherein the image processor superimposes the image signals obtained from the image sensor through multiple captures.

27. The image acquisition unit according to claim 21, further comprising a reimaging optical system configured to condense, on an imaging surface of the image sensor, light from the mirror unit.

28. The image acquisition unit according to claim 21, wherein the image acquisition unit is a digital microscope.

29. An optical system comprising:
an imaging optical system configured to form an optical image of an object; and
a mirror unit configured to reflect light from the image optical system to the image sensor
wherein the mirror unit includes:
a plurality of reflectors, each having a reflection surface;
a flexible member configured to connect the plurality of reflectors to each other;
a driver configured to apply a driving force to at least one of the reflector and the flexible member so as to change at least one of a position and a tilt of the reflection surface of each of the plurality of reflectors; and
a connector configured to connect the driver to at least one of the reflector and the flexible member, the connector being rotatable so as to change a light reflecting direction by the at least one reflection surface.

30. The optical system according to claim 29, further comprising a reimaging optical system configured to condense, on an imaging surface of the image sensor, light from the mirror unit.
